(19) United States
(12) Patent Application Publication
(10) Pub. No.: US 2011/0188074 A1
(43) Pub. Date: Aug. 4, 2011

(54) Print processing device

(75) Inventor: Shinichi Nakano, Osaka (JP)

(73) Assignee: Sharp Kabushiki Kaisha, Osaka (JP)

(21) Appl. No.: 12/931,238

(22) Filed: Jan. 26, 2011

(30) Foreign Application Priority Data
Jan. 29, 2010 (JP) JP2010-017610

(51) Int. Cl. G06F 3/12

(52) U.S. Cl. 358/1.15

(57) ABSTRACT

A print processing device includes a print processing portion, a first setting portion, a second setting portion, a priority information retaining portion, and a control portion. The print processing portion executes print processing on paper, based on a print job request. The first setting portion receives input of setting of priority information. The second setting portion receives input of setting of a time zone where the priority information is set. The priority information retaining portion retains a relationship between the priority information and the time zone. The control portion performs priority processing in which the print job request is preferentially supplied to the print processing portion, the print job request being inputted from the information processing device determined to have a higher priority in the time zone including current time based on the relationship retained in the priority information retaining portion.

### CROSS REFERENCE

This Nonprovisional application claims priority under 35 U.S.C. §119(a) on Patent Application No. 2010-017610 filed in Japan on Jan. 29, 2010, the entire contents of which are hereby incorporated by reference.

### BACKGROUND OF THE INVENTION

The present invention relates to a print processing device that executes print processing, based on a print job request outputted from each of a plurality of information processing devices connected through a network.

Among print processing devices, some print processing devices execute print processing on paper based on a print job request outputted from each of a plurality of information processing devices connected through a network, the print job request including a print job execution request to perform print processing based on image data and a print job request including the image data. Conventional print processing devices execute print jobs in an input order of the print job requests. When a user desires to cause his or her own print job to be preferentially executed in a conventional print processing device, it is necessary to discuss with another user to ask him or her to interrupt the use of his or her print processing device in a predetermined time period, or to make setting of priority processing such as interrupt processing or the like by hand operation in the print processing device, every time a print job request is outputted.

However, in the conventional print processing device, the necessity to discuss with another user or to make setting of the priority processing by the hand operation every time the user desires to cause his or her own print job to be preferentially executed in the print processing device places a large burden on the user.

Consequently, a technique has been proposed, in which an interrupt allowance data amount is set based on a data amount of the current print job, and when a print job to be print-processed next is inputted, the current print job is interrupted to perform interrupt processing if a data amount of this print job is not larger than the interrupt allowance data amount (e.g., refer to Japanese Patent Application Laid-Open No. 2000-353068).

However, in the conventional print processing device described in Japanese Patent Application Laid-Open No. 2000-353068, the interruption processing of a print job of a larger data amount than the interrupt allowance data amount is disabled. Thus, every time a data amount of a print job for which the interrupt processing is desired to be performed is larger than the interrupt allowance data amount, the necessity to discuss with another user or to make setting of priority processing by hand operation arises, which places a large burden on the user.

On the other hand, when setting is made to always give top priority to a print job request outputted by a specific user A, every time another user B desires to perform priority processing for his or her own print job request, the user B needs to discuss with another user or to make setting of priority processing by hand operation, which increases a burden on the user B.

### SUMMARY OF THE INVENTION

An object of the present invention is to provide a print processing device capable of performing priority processing while suppressing a burden on a user and another user.

A print processing device of the present invention includes a print processing portion, a storage portion, a first setting portion, a second setting portion, a priority information retaining portion, and a control portion. The print processing portion executes print processing on paper based on a print job request including a print job execution request to perform print processing based on image data and a print job request including the image data, the print job request being outputted from each of a plurality of information processing devices connected through a network. The storage portion stores the print job requests inputted from the plurality of information processing devices to be supplied to the print processing portion. The first setting portion receives input of setting of priority information indicating priority of at least one of the plurality of information processing devices over the other information processing devices. The second setting portion receives input of setting of a time zone where the priority information is set. The priority information retaining portion retains a relationship between the priority information and the time zone inputted from the first setting portion and the second setting portion, respectively. The control portion determines levels of the priority of the information processing devices in a time zone including current time, the devices being output sources of the print job requests stored in the storage portion, based on the relationship retained in the priority information retaining portion, when the plurality of print job requests stored in the storage portion exist. Moreover, the control portion performs priority processing in which based on the determination result, the print job request inputted from the information processing device determined to have a higher priority is preferentially supplied to the print processing portion.

In this configuration, the input of two types of setting of the priority information and the time zone where the priority information is set is performed in advance. In the time zone with the priority information set, if there are a plurality of print job requests stored in the storage portion, including a print job request just inputted, when the print job request is inputted, levels of the priority of the information processing deices as output sources of the print job requests in the time zone including current time, that is, an input time of the print job request, are determined. Based on the determination result, the priority processing is performed so that the print processing of the print job request inputted from the information processing device with a higher priority is preferentially executed. Thus, in the time zone in which the priority of his or her own information processing device is set to be higher, a user can cause his or her own print job to be preferentially executed without discussing with another user and making setting of the priority processing by hand operation. On the other hand, since the priority of the specific user is set to be higher only in a part of the time zones, the users other than the above-mentioned specific user can also set the time zones when their own print jobs can be preferentially executed without discussing with another user and making setting of the priority processing by hand operation. Moreover, in the time zone without priority information, the print processing is executed in the input order of the print job requests.

According to the present invention, the priority processing can be performed while suppressing a burden on a specific user and other users.

### BRIEF DESCRIPTION OF THE DRAWINGS

FIG. 1 is a block diagram showing a configuration of a print processing device according to an embodiment of the present invention;

FIG. 2 is a diagram showing one example of a configuration of a print job request;

FIG. 3 is a diagram showing one example of relationships between priority information and time zones;

FIG. 4 is a time chart showing one example of print processing under the relationships between the priority information and the time zones shown in FIG. 3;

FIG. 5 is a time chart showing another example of the print processing under the relationship between the priority information and the time zones shown in FIG. 3;

FIG. 6 is a diagram showing another example of the relationships between the priority information and the time zones;

FIG. 7 is a time chart showing one example of the print processing under the relationships between the priority information and the time zones shown in FIG. 6;

FIG. 8 is a diagram showing still another example of the relationships between the priority information and the time zones; and

FIG. 9 is a time chart showing one example of relationships among the priority information, the time zones and operation modes.

### DETAILED DESCRIPTION OF THE INVENTION

Hereinafter, an embodiment of the present invention will be described with reference to the drawings.

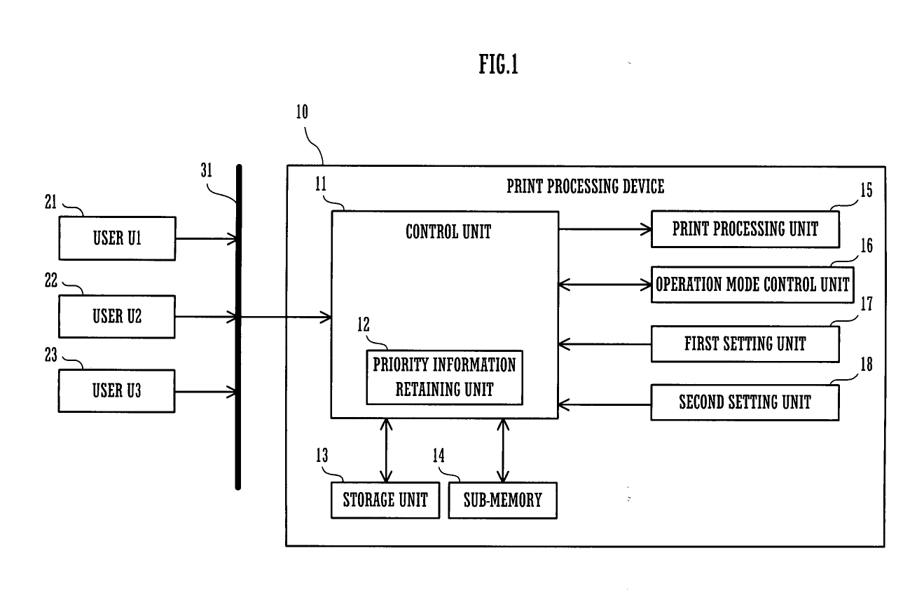

As shown in FIG. 1, to a print processing device 10 are connected a plurality of information processing devices 21, 22, 23 through a network 31. Hereinafter, as an example, a description is given on the assumption that the information processing device 21 is used by a user U1, the information processing device 22 is used by a user U2, and the information processing device 23 is used by a user U3.

The print processing device 10 includes a control portion 11, a priority information retaining portion 12, a storage portion 13, a sub-memory 14, a print processing portion 15, an operation mode control portion 16, a first setting portion 17, and a second setting portion 18. As an example, the priority information retaining portion 12 is included in the control portion 11. The control portion 11 has a clock function of acquiring information of the current time.

Print job requests outputted from the information processing devices 21 to 23 are inputted to the control portion 11 through the network 31 and a communication portion (not shown). The control portion 11 causes the storage portion 13 to store the print job requests inputted from the information processing devices 21 to 23.

The storage portion 13 stores the print job requests inputted from the information processing devices 21 to 23 until each print job has been completed in the print processing portion 15. The control portion 11 deletes the print job request of the completed print job from the storage portion 13 when the print job is completed.

The first setting portion 17 receives input of setting of priority information. The priority information indicates priority of at least one of the plurality of information processing devices 21 to 23 over the other information processing devices. The second setting portion 18 receives input of setting a time zone where the priority information is set. A configuration can also be such that a specific user inputs a management ID from any one of the information processing devices 21 to 23 connected to the print processing device 10 to thereby perform the input of the setting of the priority information and the time zone where the priority information is set. In this case, the information processing device used by the specific user owning this management ID configures the first setting portion 17 and the second setting portion 18.

The priority information retaining portion 12 retains a relationship between the priority information and the time zone inputted from the first setting portion 17 and the second setting portion 18, respectively. The relationship between the priority information and the time zone is set prior to the input of the print job requests, and retained in the priority information retaining portion 12. Details of the priority information will be described later.

The print processing portion 15 executes print processing on paper such as plain paper, printing paper, an OHP film and the like based on a print job request. The print processing portion 15, as an example, executes electrophotographic type print w processing. The print processing portion 15 can also be configured such that print processing other than the electrophotographic type print processing, such as an ink-jet type print processing, can be executed.

The print processing device 10 operates in either operation mode of a normal mode in which power supply to the print processing portion 15 is performed or an energy saving mode in which the power supply to at least the print processing portion 15 is stopped. The operation mode control portion 16 switches between the normal mode and the energy saving mode based on an instruction of the control portion 11. Switching from the normal mode to the energy saving mode is made when print processing is continuously unexecuted for a predetermined time. Switching from the energy saving mode to the normal mode is made, for example, when a print job request is inputted.

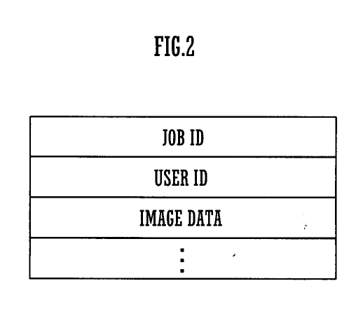

As shown in FIG. 2, the print job request is electronic data including an execution request of a print job to perform the print processing based on image data, and the image data. Specifically, the print job request includes at least a job ID, a user ID, and the image data. The job ID is an identification symbol of the print job, and as an example, configures the execution request of the print job. The user ID is an identification symbol of the information processing device that has outputted the print job request.

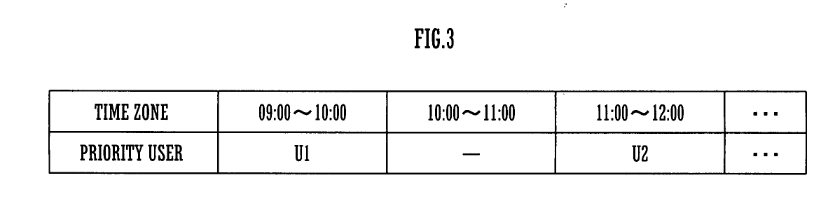

As an example shown in FIG. 3, the priority information retaining portion 12 retains the relationships between the priority information and the time zones. The time zones include a time zone with the priority information set and a time zone with the priority information unset. The priority information of the information processing devices 21 to 23 is described as the is priority information of the users U1 to U3 for convenience of description. The information processing device 21 corresponds to the user U1, the information processing device 22 corresponds to the user U2, and the information processing device 23 corresponds to the user U3.

The control portion 11, in principle, supplies the print job request to the print processing portion 15 so that the print jobs are executed in the input order of the print job requests. However, as exception, in the time zone with the priority information set, the control portion 11 preferentially supplies the print processing portion 15 with a print job request inputted from the information processing device determined to have a higher priority so that a print job of the user with the higher priority is preferentially executed. For example, when the relationships between the priority information and the time zones are set as shown in FIG. 3, the control portion 11 causes the print processing portion 15 to preferentially execute a print job of the user U1 in the time zone of 9:00-10:00, and causes the print processing portion 15 to preferentially execute a print job of the user U2 in the time zone of 11:00-12:00. Since in the time zone of 10:00-11:00, the priority information is not set, the control portion 11 causes print jobs to be executed in the input order of print job requests in accordance with the principle.

It is to be noted that, a unit of the time zone where priority information is set is not limited to one hour, but several hours, 24 hours, or a shorter time than one hour can be employed.

In the case where there are a plurality of print job requests stored in the storage portion 13 when a print job request is inputted, the control portion 11 compares and determines levels of the priority of the information processing devices in a time zone including current time, the devices being output sources of the print job requests stored in the storage portion, based on the relationships between the priority information and the time zones as shown in FIG. 3 retained in the priority information retaining portion 12. Based on the determination result, the control portion 11 performs the priority processing such as the interrupt processing and the like to preferentially supply the print processing portion 15 with the print job request inputted from the information processing device determined to have a higher priority in the time zone including the current time. The print job request just inputted is counted in the print job requests stored in the storage portion 13, the number of which is determined when the print job request is inputted.

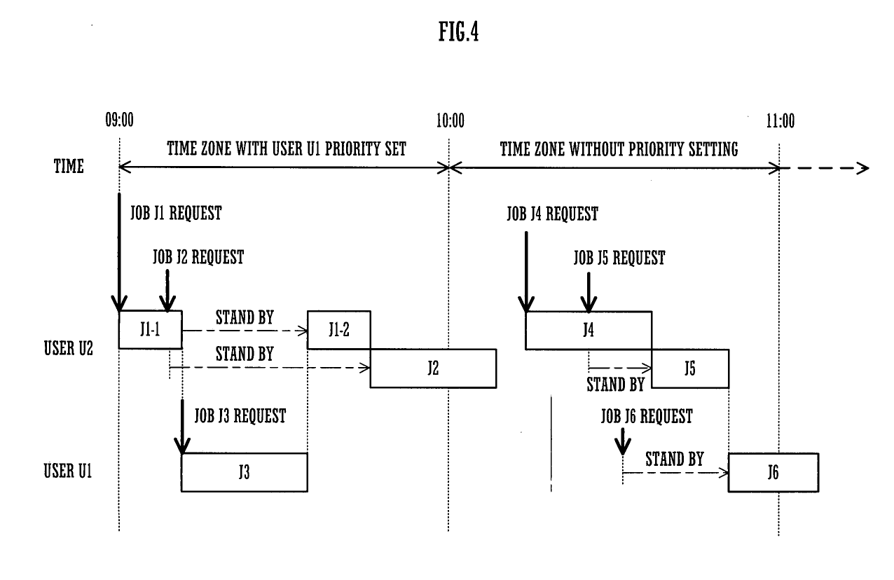

As an example, the print processing when the relationships between the priority information and the time zones are set as shown in FIG. 3 is described with reference to FIG. 4.

As shown in FIG. 4, when in a state where there is neither standby print job nor current print job, which is stored in the storage portion 13, a print job request of a print job J1 is newly inputted, the control portion 11 causes the print job request to be stored in the storage portion 13, and immediately supplies the print job request to the print processing portion 15 and causes the print job J1 to be executed. As an example, the print job J1 is inputted from the user U2.

A description is given of a case where in the time zone of 9:00-10:00, a print job request of another print job J2 of the user U2 and a print job request of a print job J3 of the user U1 are inputted during the execution of the print job J1 of the user U2. The input of the print job request of the print job J2 is performed prior to the input of the print job request of the print job J3.

The control portion 11 compares and determines levels of the priority of the users as output sources of the respective print job requests stored in the storage portion 13 when the respective print job requests of the print job J2 and the print job J3 are inputted.

The control portion 11 determines that the print job J1 has a higher priority than the print job J2 does, following the input order of the print job requests in accordance with the principle, because the print job J1 and the print job J2 are inputted by the same user U2 and the priority of the users is the same. As a result, the control portion 11 causes the execution of the print job J1 to be continued.

On the other hand, since the print job J3 is inputted by the user U1, and the priority of the user U1 is set higher in the time zone of 9:00-10:00, the control portion 11 determines the priority of the print job requests of the print job J1, the print job J2, and the print job J3 stored in the storage portion 13 when the print job request of the print job J3 is inputted, and as a result, determines that the print job J3 has a higher priority than the print job J1 and the print job J2 do.

The control portion 11 supplies the print job request of the print job J3 to the print processing portion 15, as an example, immediately after the determination of the priority. As a result, the interrupt processing of interrupting the current print job J1 and executing the print job J3 of the print job request inputted from the information processing device 21 (the user U1) with a higher priority is performed. This allows the user U1 to start his or her own print job J3 without waiting time.

A part of the print job J1 for which the print processing has been executed is a print job J1-1, and the remaining part is a print job J1-2.

When the print job J1 being executed is interrupted, and the interrupt processing is performed, the control portion 11 causes a print job request of the remaining print job J1-2 to be stored in the sub-memory 14, and after the print job J3, which was executed by the interrupt processing, has been completed, restarts the interrupted print job J1 at an interrupted position. Once the print job J1-2 of the remaining portion of the print job J1 interrupted by the interrupt processing has been completed, the control portion 11 deletes the print job request of the print job J1-2 from the sub-memory 14.

More specifically, once the print job J3 has been completed, the control portion 11 determines the priority of the print job J1 and the print job J2 for which the print processing has not been completed. The control portion 11 determines that the print job J1 has a higher priority than the print job J2 does, and based on this determination result, and after the print job J3 executed by the interrupt processing has been completed, causes the remaining print job J1-2 of the print job J1 to be executed. Furthermore, after the print job J1-2 has been completed, the control portion 11 causes the print job J2 to be executed.

A description is given of a case where in the time zone of 10:00-11:00, a print job request of another print job J5 of the user U2, and a print job request of a print job J6 of the user U1 are inputted during execution of a print job J4 of the user U2. The input of the print job request of the print job J5 is performed prior to the input of the print job request of the print job J6.

Upon the input of a print job request of the print job J4 in a state where there is no current print job, the control portion 11 immediately causes the print job J4 to be executed.

In the time zone of 10:00-11:00, the priority information is not set. Thus, the control portion 11 causes the print jobs J4 to J6 to be executed in the input order of the print job requests, that is, in the order of the print job J4, the print job J5, and the print job J6 in accordance with the principle.

According to the print processing device 10, from the standpoint of the user U1, for example, in the time zone of 9:00-10:00 in which the priority of the information processing device 21 used by himself or herself is set higher, his or her own print job J3 can be preferentially executed without discussing with the other users U2, U3 and making setting of the priority processing by hand operation in the print processing device 10. On the other hand, since the priority of the specific user U1 is set higher, for example, in only a part of the time zones such as 9:00-10:00, the users U2, U3 other than the specific user U1 can also set the time zones such that their own print jobs can be preferentially executed without discussing with the other users and making the setting of the priority processing by hand operation, for example, such as the time zone of 11:00-12:00 in FIG. 3. Moreover, for example, in the time zone of 10:00-11:00 without the priority information, the print processing is executed in the input order of the print job requests. Accordingly, the priority processing can be performed while suppressing a burden on a specific user and other users. Moreover, since when a print job request is inputted from the information processing device 21 with a higher priority, the print processing is interrupted to perform the interrupt processing immediately at a time point when the print processing of a page being processed is finished, even if unprocessed pages remain in the print job J1 to be executed, the print processing of the print job request inputted from the information processing device 21 with a higher priority can be started to be executed earlier.

Furthermore, restarting the interrupted print job J1 at the interrupted position allows the interrupted print job J1 to be completed earlier than a case where the print processing is started all over again. Moreover, waste of paper can be suppressed.

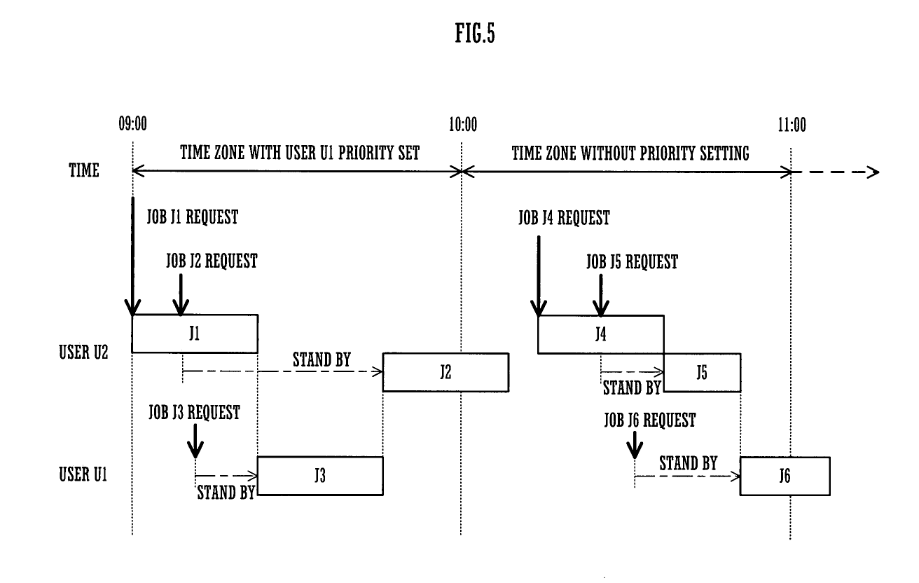

As shown in FIG. 5, the control portion 11 can be configured so as to perform the priority processing in which when in the time zone of 9:00-10:00 with the priority information set, the print job request of the print job J3 is inputted from the information processing device 21 (the user U1) with a higher priority than the information processing device 22 (the user U2) as the output source of the print job J1 being executed, the priority of the standby print jobs J2, J3 is changed based on the priority information, and the print processing is executed in order from the print job J3 with a higher priority after the print job J1 being executed has been completed.

In the example shown in FIG. 5, in the time zone of 9:00-10:00, the control portion 11 supplies the print processing portion 15 with the print job requests in order from the print job request of the print job J3 with a higher priority after the print job J1 being already executed at a time point when the print job request of the print job J3 is inputted has been completed. As a result, the execution of the print job J3 stands by until the print job J1 being executed has been completed, and after the print job J1 has been completed, the print job J3 is immediately executed in preference to the print job J2. The control portion 11 causes the print job J2 to be executed after the print job J3 has been completed.

The example shown in FIG. 4 is also applied to processing in the time zone of 10:00-11:00 with the priority information unset.

Even when the print job request is inputted from the information processing device 21 with a higher priority, by first completing the print job J1, which has been started to be executed, expectation of the user U2, who requested the print job J1 started to be executed, that the print processing will be completed before long can be lived up to, and thus, the print processing can be performed without collapsing a work schedule of the user U2 who requested the print job J1 started to be executed.

Moreover, referring to FIG. 5, the control portion 11 can be configured such that when in the time zone of 9:00-10:00 with the priority information set, the plurality of standby print jobs J2, J3 exist, the priority between the plurality of standby print jobs J2, J3 is set based on the priority information, and after the print job J1 being executed has been completed, the standby print jobs are executed in order from the print job J3 with a higher priority.

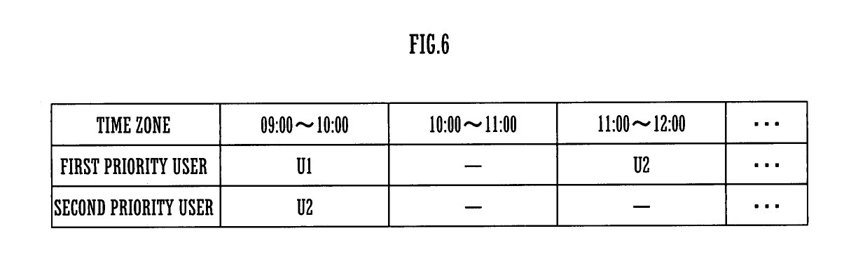

As shown in FIG. 6, the priority information can be configured so as to include information of the priority at three or more levels relating to the plurality of information processing devices 21 to 23, that is, the priority at three or more levels relating to the users U1 to U3. In this case as well, the control portion 11 executes the print processing of the print job requests in order from the print job request inputted from the user with a higher priority.

In the example shown in FIG. 6, in the time zone of 9:00-10:00, the user U1 is set as the first priority user, the user U2 is set as the second priority user, and the level of the priority of the user U3 is set as standard. In the time zone of 10:00-11:00, the priority information is not set. In the time zone of 11:00-12:00, the user U2 is set as the first priority user, and the second priority user is not set.

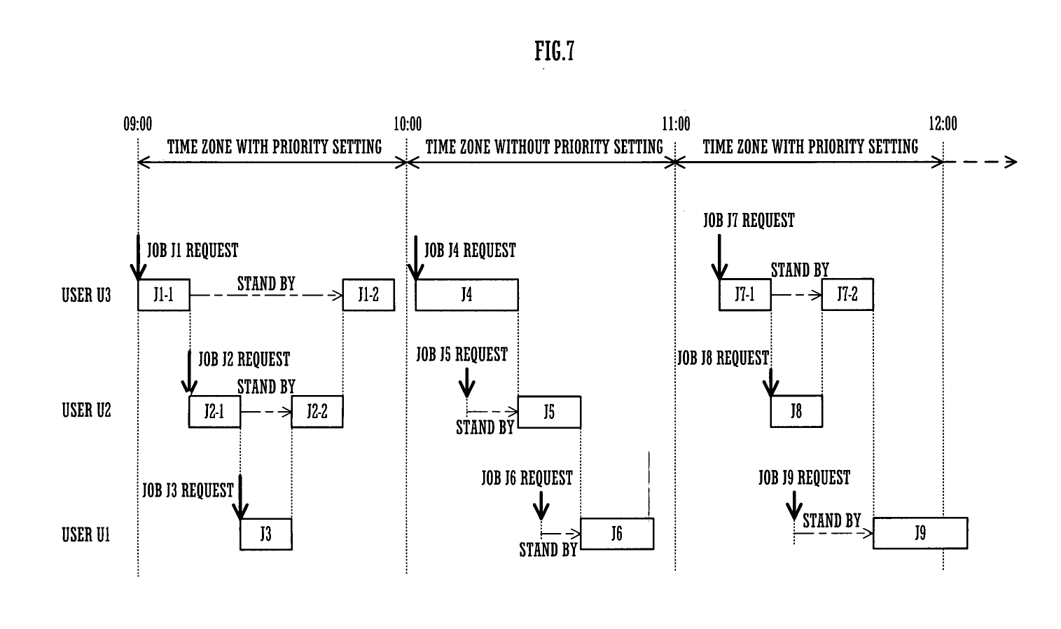

With reference to FIG. 7, a description is given of the print processing in the case where the relationships between the priority information and the time zones are set as shown in FIG. 6.

As shown in FIG. 7, when the print job request of the print job J1 is newly inputted in the state where neither standby print job nor current print job is stored in the storage portion 13, the control portion 11 causes the print job request to be stored in the storage portion 13, and immediately supplies the print job request to the print processing portion 15 to execute the print job J1. As an example, the print job J1 is inputted from the user U3.

A description is given of a case where in the time zone of 9:00-10:00, the print job request of the print job J2 of the user U2 is inputted during execution of the print job J1 of the user U3, and then, the print job request of the print job J3 of the user U1 during execution of the print job J2 is inputted. That is, the print job requests are inputted in the order of the print job J1, the print job J2, and the print job J3.

The control portion 11 compares and determines the levels of the priority of the users as the output sources of the print job requests stored in the storage portion 13 when the respective print job requests of the print job J2 and the print job J3 are inputted.

In the time zone of 9:00-10:00, the user U2 is set as the second priority user, and the priority of the user U3 is set as standard. The control portion 11 thus determines the priority of the print job requests of the print job J1 and the print job J2 stored in the storage portion 13 when the print job request of the print job J2 is inputted, and as a result, determines that the print job J2 of the user U2 has a higher priority than the print job J1 of the user U3.

The control portion 11 supplies the print job request of the print job J2 to the print processing portion 15, as an example, immediately after the determination of the priority. As a result, the print job J1 being executed is interrupted to perform the interrupt processing for executing the print job J2.

Moreover, in the time zone of 9:00-10:00, while the user U2 is set as the second priority user, the user U1 is set as the first priority user. Thus, the control portion 11 determines the priority of the print job requests of the print job J1, the print job J2, and the print job J3 stored in the storage portion 13 when the print job request of the print job J3 is inputted, and as a result, determines that the print job J3 of the user U1 has a higher priority than the print job J1 of the user U3 and the print job J2 of the user U2.

As an example, immediately after the determination of the priority, the control portion 11 supplies the print job request io of the print job J3 to the print processing portion 15 so that the print job J3 is executed in preference to the print job J1 and the print job J2. As a result, the print job J2 being executed is interrupted to perform the interrupt processing for executing the print job J3. Thus, the user U1 can start his or her own print job J3 without waiting time.

The portion of the print job J1 for which the print processing has been executed is the print job J1-1, and the remaining portion is the print job J1-2. Similarly, a portion of the print job J2 for which the print processing has been executed is a print job J2-1, and the remaining portion is a print job J2-2.

When the print job J1 being executed is interrupted to perform the interrupt processing, the control portion 11 causes the remaining print job J1-2 to be stored in the sub-memory 14, and after the print job J2 executed by the interrupt processing has been completed, restarts the interrupted print job at a interrupted position. Similarly, when the print job J2 being executed is interrupted to perform the interrupt processing, the control portion 11 causes the remaining print job J2-2 to be stored in the sub-memory 14, and after the print job J3 executed by the interrupt processing has been completed, restarts the interrupted print job J2 at a interrupted position.

That is, once the print job J3 has been completed, the control portion 11 causes the remaining print job J2-2 of the print job J2 with a higher priority in the print job J1 and the print job J2 for which the print processing has not been completed to be executed, and after the print job J2-2 has been completed, causes the print job J1-2 to be executed.

A description is given of a case where in the time zone of 10:00-11:00, the print job request of the print job J4 of the user U3, the print job request of the print job J5 of the user U2, and the print job request of the print job J6 of the user U1 are inputted in this order.

In the time zone of 10:00-11:00, the priority information is not set. The control portion 11 thus causes the print jobs J4 to J6 to be executed in the input order of the print job requests, that is, the order of the print job J4, the print job J5 and the print job J6 in accordance with the principle. That is, the control portion 11 causes the print job J4 to be executed, immediately after the print job J4 has been completed, and causes the print job J5 to be executed. Furthermore, immediately after the print job J5 has been completed, the control portion 11 causes the print job J6 to be executed.

A description is given of a case where in the time zone of 11:00-12:00, a print job request of a print job J8 of the user

U2 is inputted during execution of a print job J7 of the user U3, and then a print job request of a print job J9 of the user U1 is inputted during the execution of the print job J8. That is, the print job requests are inputted in the order of the print job J7, the print job J8 and the print job J9.

The control portion 11 compares and determines levels of the priority of the users as output sources of the respective print job requests stored in the storage portion 13, when the respective print job requests of the print job J8 and the print job J9 are inputted.

In the time zone of 11:00-12:00, the user U2 is set as the first priority user, and on the other hand, the priority of the user U3 and the user U1 is set as standard. Thus, the control portion 11 determines the priority of the print job requests of the print job J7 and the print job J8 stored in the storage portion 13 when the print job request of the print job J8 is inputted, and as a result, determines that the print job J8 of the user U2 has a higher priority than the print job J7 of the user U3.

The control portion 11 supplies the print job request of the print job J8 to the print processing portion 15, as an example, immediately after the determination of the priority. As a result, the print job J7 being executed is interrupted to perform the interrupt processing for executing the print job J8.

A portion of the print job J7 for which the print processing has been executed is a print job J7-1, and the remaining portion is a print job J7-2. When the print job J7 is interrupted, the control portion 11 causes the remaining job J7-2 to be stored in the sub-memory 14.

Moreover, the control portion 11 determines the priority of the print job requests of the print job J7, the print job J8 and the print job J9 stored in the storage portion 13 when the print job request of the print job J9 is inputted, and as a result, determines that the print job J8 of the user U2 has a higher priority than the print job J7 of the user U3 and the print job J9 of the user U1, thereby continuing to execute the print job J8.

When the print job J8 is completed, the control portion 11 determines the priority of the print job J7 and the print job J9 stored in the storage portion 13 at this time point. Since the priority of both the user U3 and the user U1 is set as standard in this time zone, the control portion 11 determines that the print job J7 whose print job request has been inputted first has a higher priority than the print job J9 in accordance with the principle, and after the print job J8 has been completed, causes the remaining print job J7-2 of the print job J7 to be executed, and after the print job J7-2 has been completed, causes the print job J9 to be executed.

In the case where the priority information includes information of the priority at four or more levels as well, the control portion 11 processes similarly to the processing as shown in FIG. 7.

Setting the priority at three or more levels as shown in FIGS. 6 and 7 allows the print jobs J2, J3 of the plurality of users U1, U2 to be preferentially executed without discussing with the other users and making setting of the priority processing by hand operation.

In the case where the priority information includes the information of the priority at three or more levels as shown in FIG. 6, the configuration can also be such that the priority processing is performed, in which in place of the interruption processing, the priority of the standby print jobs is changed based on the priority information, and after the current print job has been completed, the print jobs are executed in order from the print job with a higher priority.

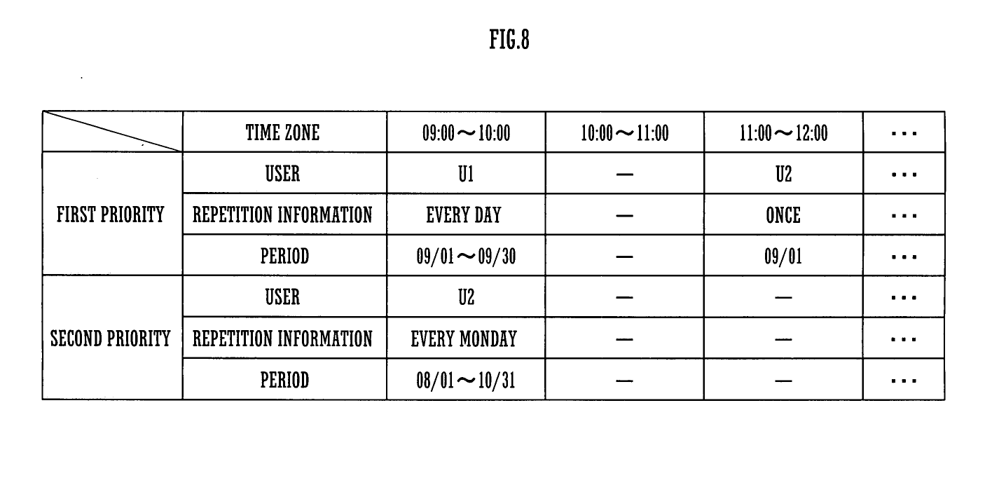

As shown in FIG. 8, a configuration can also be employed, in which the priority information retaining portion 12 further retains repetition information of a time zone with the priority information set, and the control portion 11 repeatedly performs the priority processing based on the priority information in accordance with the repetition information. As the repetition information, for example, information indicating whether to perform the priority processing every day, every Monday, only once or the like is set.

Moreover, a configuration can also be employed, in which the priority information retaining portion 12 further retains information of a period when the priority processing based on the priority information is performed, and the control portion 11 repeatedly performs the priority processing based on the priority information in the period.

In an example shown in FIG. 8, in a period of September 1 to September 30, in the time zone of 9:00-10:00, the user U1 is set as the first priority user, and every Monday in a period of August 1 to October 31, in the time zone of 9:00-10:00, the user U2 is set as the second priority user.

Moreover, in the time zone of 10:00-11:00, the priority information is not set, and the print jobs are executed in the input order of the print job requests in accordance with the principle.

Furthermore, in the time zone of 11:00-12:00 on September 1, the user U2 is set as the first priority user and the second priority user is not set.

In this manner, in a part of time zones, the priority processing can be performed while suppressing the burden on the specific user, and since the time zone when the specific user has priority is only a part, burdens on the other users can also be suppressed.

Moreover, since the repetition information indicating whether in the time zone with the priority information set, the priority processing is performed, for example, every day, only every Monday or the like can be set, the trouble of resetting the priority information can be saved.

Furthermore, a situation as to which of the users should have a higher priority to suppress a burden on his or her own and other users most may vary depending on a period, and if the priority information remains set the same although the situation varies, the burden on his or her own and other users may be increased. In the print processing device 10, however, setting the period of the priority information in advance allows the priority processing to be performed while suppressing a burden on his or her own and the other users.

As described above, the print processing device 10 operates in either operation mode of the normal mode or the energy saving mode.

As an example, in a time zone of 8:00-9:00, the priority information is not set, and in the time zone of 9:00-10:00, the user U1 is set as a priority user.

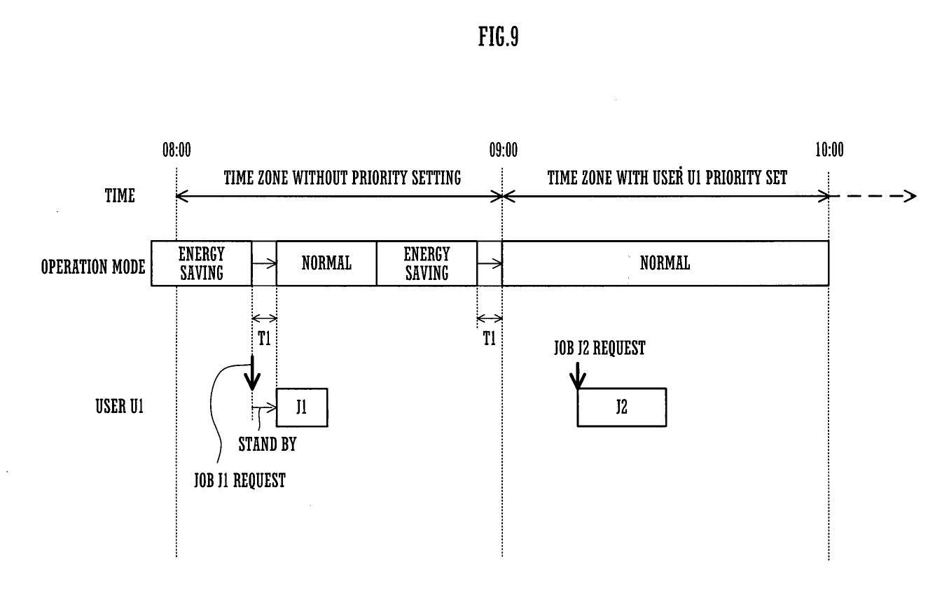

As shown in FIG. 9, the print processing device 10 can be configured to operate in the normal mode in the time zone of, for example, 9:00-10:00 with the priority information set, regardless of an elapsed time since the last print processing is executed.

It is preferable that when the print processing device 10 is in the energy saving mode a predetermined time before the time zone of 9:00-10:00 with the priority information set, the control portion 11 starts the shift from the energy saving mode to the normal mode in advance by a return time T1 required for the return from the energy saving mode to the normal mode so that the shift to the normal mode is completed at a start time (e.g., at 9:00) of the time zone (e.g., 9:00-10:00) with the priority information set. The predetermined time for indicating the timing at which the control portion 11 determines whether or not the device is in the energy saving mode is a little longer (e.g., one minute) than the return time T1 from the energy saving mode to the normal mode.

In the time zone of, for example, 8:00-9:00 with the priority information unset, the control portion 11 shifts the device from the normal mode to the energy saving mode when the print processing is continuously unexecuted in a predetermined time, and when a print job request of a print job (e.g., the print job J1) of any one of the users is inputted in the energy saving mode, the control portion 11 immediately starts the return from the energy saving mode to the normal mode, and when the return from the normal mode is completed, immediately executes the print job J1. However, if the device is in the energy saving mode when the print job request is inputted, the user U1 will have a waiting time corresponding to the return time from the energy saving mode to the normal mode.

On the other hand, since in the time zone with the priority information set, the device constantly operates in the normal mode, the user U1 can cause the print job to be executed without waiting the return time from the energy saving mode to the normal mode. For the user U1 set to have a higher priority, in the time zone when possibility or frequency that the user U1 uses the print processing device 10 is high, the priority information ought to be set so that his or her priority is set to be high, which increases convenience particularly for the user U1 whose priority is set to be higher.

It is to be noted that the functions of the first setting portion 17 and the second setting portion 18 can be executed in the same CPU.

The descriptions of the foregoing embodiment should be considered to be illustrative in all points, not limitative. The scope of the present invention is indicated not in the embodiment, but in the scope of claims. Furthermore, the scope of the present invention is intended to include meanings equivalent to the scope of the claims and all modifications within the scope of the claims.

What is claimed is:

1. A print processing device comprising:
a print processing portion that executes print processing on paper, based on a print job request including an execution request of a print job to perform the print processing based on image data, and the image data, the print job request being outputted from each of a plurality of information processing devices connected through a network;
a storage portion that stores the print job requests inputted from the plurality of information processing devices to be supplied to the print processing portion;
a first setting portion that receives input of setting of priority information indicating priority of at least one of the plurality of information processing devices over the other information processing devices;
a second setting portion that receives input of setting of a time zone where the priority information is set;
a priority information retaining portion that retains a relationship between the priority information and the time zone inputted from the first setting portion and the second setting portion, respectively; and
a control portion that determines the priority of the information processing devices in a time zone including current time, the devices being output sources of the print job requests stored in the storage portion, based on the relationship retained in the priority information retaining portion when the plurality of print job requests stored in the storage portion exist, the control portion performing the priority processing in which based on the determination result, the print job request inputted from the information processing device determined to have a higher priority is preferentially supplied to the print processing portion.

2. The print processing device according to claim 1, wherein
the control portion performs interrupt processing for interrupting a current print job and executing print processing of a new print job request when the new print job request is inputted from the information processing device with a higher priority than the information processing device of the current print job.

3. The print processing device according to claim 2, wherein
when the current print job is interrupted, the control portion restarts the interrupted print job at a interrupted position, after the current print job by the interrupt processing has been completed.

4. The print processing device according to claim 1, wherein
when the print job request is inputted from the information processing device with a higher priority than the information processing device as an output source of the current print job, the control portion changes the priority of the standby print jobs based on the relationship to cause the print jobs to be executed in order from the print job with a higher priority after the current print job has been completed.

5. The print processing device according to claim 1, wherein
the priority information includes information of the priority at three or more levels relating to the plurality of information processing devices, and
the control portion causes the print processing to be executed in order from the print processing of the print job request inputted from the information processing device with a higher priority.

6. The print processing device according to claim 1, wherein
the priority information retaining portion further retains repetition information of a time zone with the priority information set, and
the control portion repeatedly performs the priority processing based on the relationship in accordance with the repetition information.

7. The print processing device according to claim 6, wherein
the priority information retaining portion further retains information of a period when the priority processing based on the relationship is performed, and
the control portion repeatedly performs the priority processing based on the relationship in the period.

8. The print processing device according to claim 1 that operates in either operation mode of a normal mode in which power supply to the print processing portion is performed and an energy saving mode in which the power supply to at least the print processing portion is stopped when the print processing is unexecuted continuously in a predetermined time,
in the time zone with the priority information set, the print processing device operating in the normal mode, regardless of an elapsed time since the last print processing was executed.

9. The print processing device according to claim 1, wherein
when the standby print job becomes plural, the control portion sets the priority between the plurality of standby print jobs based on the relationship, and causes the print jobs to be executed in order from the print job with a higher priority after the current print job has been completed.
